(19) United States
(12) Patent Application Publication
(10) Pub. No.: US 2015/0199293 A1
(43) Pub. Date: Jul. 16, 2015

(54) METHOD AND APPARATUS WITH INTERFACE FOR REDUNDANT ARRAY OF INDEPENDENT MODULES

(71) Applicant: Hangzhou Dianzi University, Hangzhou City (CN)

(72) Inventors: Lingyan Fan, Hangzhou City (CN); Shi Wang, Hangzhou City (CN); Chris Tsu, Saratoga, CA (US)

(21) Appl. No.: 14/668,920

(22) Filed: Mar. 25, 2015

Related U.S. Application Data
(63) Continuation-in-part of application No. 14/085,469, filed on Nov. 20, 2013.

(51) Int. Cl. G06F 13/42; G06F 13/38; G06F 12/02

(52) U.S. Cl. CPC G06F 13/4221; G06F 12/0246; G06F 13/385; G06F 2213/0032; G06F 2212/7208

(57) ABSTRACT

A storage controller with Universal Flash Storage (UFS) interface includes a series bus controller responsive to information from a first externally-located host, and a microprocessor coupled to the series bus controller and responsive to the information, and one or more UFS host interfaces responsive to the output from the microprocessor and operable to generate information to one or more externally-located UFS devices. The number of externally-located UFS devices is equal to the number of UFS host interfaces, wherein the UFS host devices cause simultaneous communication of at least some of the information to the externally-located UFS devices.

### CROSS REFERENCE TO RELATED APPLICATIONS

This application is a continuation-in-part of U.S. patent application Ser. No. 14/085,469, filed on Nov. 20, 2013, by Jianjun Luo, et al., and entitled “REDUNDANT ARRAY OF INDEPENDENT MODULES”.

### BACKGROUND

Various embodiment of the invention relate generally to memory cards and particularly to memory card readers.

Memory cards offer portability for transferring and/or maintaining large amounts of data, in various forms, and are therefore widely employed. Examples of information stored in memory cards are video, pictures, data files, and a host of other types of information.

As memory has dropped in price and size, applications employing memory, such as memory card readers, have benefitted greatly. A memory card today has a memory capacity orders of magnitude more than those of, for example, five years ago and cost less than an equivalent memory card if it would have been possible to make such memory cards. Memory cards are expected to continue to enjoy these benefits in the future.

Security is a near-must for the protection of information to guard against or at least reduce the risk of information theft. Unfortunately, as is well known, identity theft has been a major concern. Portability of sensitive information, in a memory card, presents at times catastrophic risks.

Further, the transfer of information from a memory card to a host machine, for example from a portable memory drive to a personal computer (PC), currently takes time. Needless to say, this is, at a minimum, inconvenient for users of memory cards. Performance of the memory card is hindered by current controllers that are employed to read saved information transferred from a memory card to a host.

Accordingly, there is a need for card readers with higher performance and security.

### SUMMARY

Briefly, A storage controller with Universal Flash Storage (UFS) interface includes a series bus controller responsive to information from a first externally-located host, and a microprocessor coupled to the series bus controller and responsive to the information, and one or more UFS host interfaces responsive to the output from the microprocessor and operable to generate information to one or more externally-located UFS devices. The number of externally-located UFS devices is equal to the number of UFS host interfaces, wherein the UFS host devices cause simultaneous communication of at least some of the information to the externally-located UFS devices.

A further understanding of the nature and the advantages of particular embodiments disclosed herein may be realized by reference of the remaining portions of the specification and the attached drawings.

### BRIEF DESCRIPTION OF THE DRAWINGS

FIG. 1 shows a storage controller with Universal Flash Storage (UFS) interface 1, in accordance with an embodiment of the invention.

FIG. 2 shows yet another embodiment of the interface 1.

FIG. 3 shows yet another embodiment of the interface 1.

FIG. 4 shows further details of the controller 11 of the interface 1, in accordance with an embodiment of the invention.

FIG. 5 shows further details of the UFS host interface 13, in accordance with various embodiments of the invention.

### DETAILED DESCRIPTION OF EMBODIMENTS

Particular embodiments and methods of the invention disclose a storage controller with a Universal Flash Storage (UFS) device interface. The UFS device interface can have one or more UFS host interfaces allowing it to communicate with multiple host devices simultaneously.

The following description describes a storage controller with a UFS device interface. The storage controller with UFS device interface employs one or more UFS interfaces causing improved performance and throughput, as discussed below.

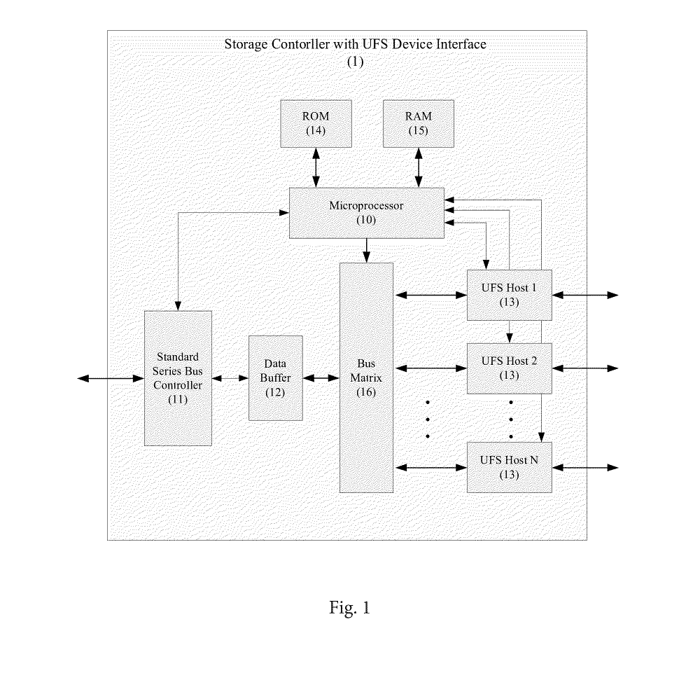

Referring now to FIG. 1, a storage controller with Universal Flash Storage (UFS) interface 1 is shown, in accordance with an embodiment of the invention. The interface 1 is shown to include a microprocessor 10 (also known as a central processor unit (CPU)), a standard series bus controller 11, data buffer 12, a UFS host interface 13, a read-only-memory (ROM) 14, and a random access memory (RAM) 15, in accordance with an embodiment of the invention.

The microprocessor 10 is shown coupled to the ROM 14, the RAM 15, the bus controller 11, the data buffer 12, and the UFS hosts 13, i.e. UFS host 1, UFS host 2, and UFS host 3. As such, the microprocessor 10 controls these structures (to which it is coupled) in the interface 1. The bus controller 11 is typically in communication with a host (not shown) through a recognized protocol interface, such as without limitation SATA. Information, in the form of data, is transferred between the interface 1 and the host through the bus controller 11 and under the direction of the microprocessor 10.

The UFS hosts 13 are typically in communication with storage devices (not shown) located externally to the interface 1, such as memory cards. Thus, information, such as data, is transferred between the interface 1 and storage device(s), located externally to the interface 1, through the host interface 13 and under the direction of the microprocessor 10. Similarly, the UFS hosts 13 allows for communication between an externally-located host device, such as computing or communication or networking devices, and the microprocessor 10. It is through the UFS hosts 13 that data or other types of information is transferred to an externally-located memory/storage devices, under the direction of the microprocessor 10. For instance, when an externally-located device is interested in accessing data stored in the RAM 15 or from the bus controller 11, microprocessor 10 retrieves the data from the RAM 15 or the bus controller 11, as the case may be, and couples it through to the UFS hosts 13 to the externally-located device(s). In the case where data is generated by the bus controller 11, data is first saved in the data buffer 12 and then passed onto the UFS hosts 13, under the direction of the microprocessor 10. Accordingly, data buffer 12 buffers information passed on from the bus controller 11 and provides the buffered data to the UFS hosts 13.

The bus controller 11 is generally compliant with an industry-adopted standard, such as Serial ATA (SATA), Peripheral Component Interconnect Express (PCIe), Universal Serial Bus (USB) and their updated version. An example of the UFS hosts 13 is a host that is compliant with the open-industry standard adopted by the Joint Electron Device Engineering Council (JEDEC), the currently-published version of its future upgrade version(s).

In various embodiments of the invention, the externally-located memory/storage devices may be compliant with, without limitation, USB, SATA or PCIe.

The interface 1 in an embodiment of the invention is made on a substrate of an integrated circuit (IC) in its entirety. In another embodiment, the interface 1 is made on more than one substrate. The engine 1 is on a single integrated circuit (IC), in an embodiment of the invention. In another embodiment of the invention, it is on multiple ICs and/or printed circuit boards (PCBs). In yet another embodiment of the invention, the card reader controller 1 is on a single PCB. In still other embodiments of the invention, some or all portions of the card reader controller 1, shown in FIG. 1, are implemented in software and/or firmware.

As shown, the ROM 14 and the RAM 15 are both shown coupled to the microprocessor 10. The ROM 14 is typically used to maintain the program (software/firmware) executed by the microprocessor 10 and the RAM 15 is typically used to maintain data and/or program employed by the microprocessor. The microprocessor 10 operates by executing code (also referred to herein as “program”) residing in the ROM 14 and/or the RAM 15.

In operation, the engine 1 receives information through the bus controller 11 and under the direction of the microprocessor 10. The received information is saved in the data buffer 12 under the control of the microprocessor 10. The microprocessor 10 ultimately causes part of all of the information received through the controller 11 to be sent to the hosts 13 for transmission to an external device.

Depending on design choices, the bus controller 11 may be compliant with known protocols/standards. In an embodiment of the invention, the bus controller 11 is compliant with the PCIe, SATA, SAS, or USB standards.

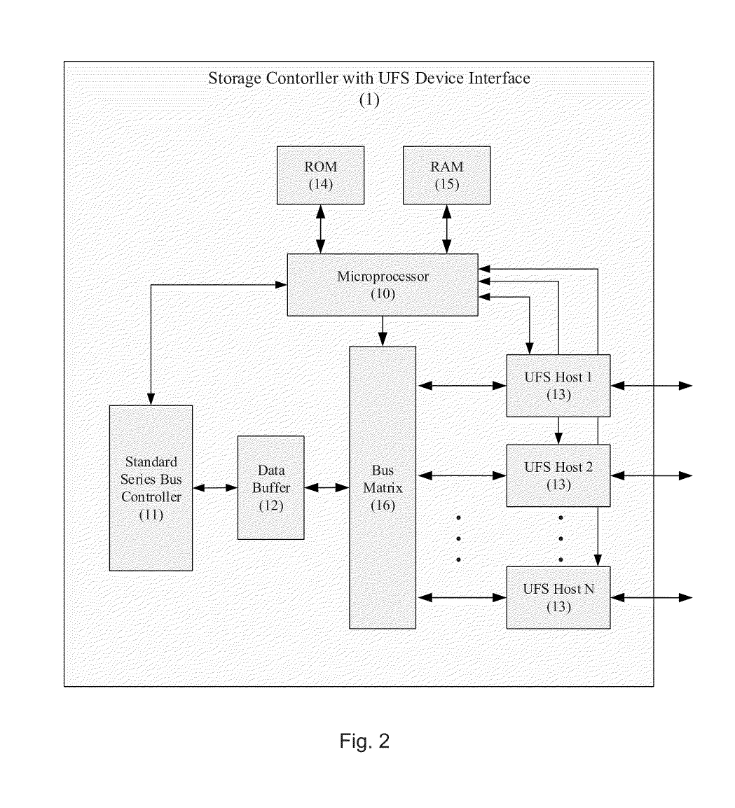

FIG. 2 shows an exemplary embodiment of a storage controller with UFS device interface of FIG. 1, in accordance with an embodiment of the invention. FIG. 2 shows the interface 1 of FIG. 2 to include multiple UFS hosts 13 coupled not only to the microprocessor 10 but also to externally-located UFS devices (1-3) 30 through the UFS bus 18. As with the case of the embodiment of FIG. 1, the throughput of the embodiment of FIG. 2 is improved because information can be transmitted in parallel or simultaneously between the UFS hosts 13 and the UFS devices 30 due to multiple UFS hosts, which communicate with the UFS devices 30 in parallel and therefore simultaneously, as each uses a separate UFS bus 18. While three UFS hosts and devices are shown and discussed herein, it is understood that an “N” number of such hosts and devices may be employed, with “N” representing an integer value.

The UFS hosts 13 are each coupled to the matrix 16, which is shown coupled to the microprocessor 10 as well as the data buffer 12. In this manner, the matrix 16, under the direction of the microprocessor 10, transmits information between the data buffer 12 and the UFS hosts (1−N) 13.

The data buffer 12 effectively acts as the data exchange buffer between the controller 11 and the N UFS hosts 13.

The matrix 16 selectively couples the UFS hosts 13 with the data buffer 12, as there may be N number of UFS host interfaces and only one data buffer 12.

In an embodiment of the invention, the microprocessor 10 is an embedded processor, with suitable capability to communicate with the protocol, parameter configuration, and commands defined by both the serial port (the communication bus between the controller 11 (or output of the controller 11) and that to which it couples) and the N number of UFS ports (the output of the hosts 13).

FIG. 3 shows yet another embodiment of the interface 1. In the embodiment of FIG. 3, the interface 1 is shown coupled to a SATA host 20. As in the embodiment of FIG. 2, through the UFS bus 18, each of the UFS hosts 13 is shown coupled to a respective externally-located UFS device 30. In the embodiment of FIG. 3, while 4 UFS hosts and 4 UFS devices are employed, it is understood that N number of UFS hosts 13 and N number of UFS devices may be used, with ‘N’ being an integer value. UFS devices are _storage devices which follows the Universal Flash Storage Specification, examples of which are UFS Storage Cards. The SATA interface 1 is shown coupled to the SATA host 20 through a SATA bus 17, in the embodiment of FIG. 3.

As described above, relative to the embodiment of FIG. 1, the interface 1 of FIGS. 2 and 3 may be formed on a single substrate or IC or multiple substrates or ICs. This applies to all of the storage controller with UFS device interface embodiments of the invention. The storage capacity on the SATA host side of the interface 1 is equal to the sum of each one of the UFS Device's capacity.

In each of the embodiments of FIGS. 2 and 3, there may be a single UFS host 13 and a single UFS device 30, in accordance with another embodiment of the invention. Further, in each of the embodiments of FIGS. 2 and 3, the controller 11 is compliant with that of the host to which it communicates. For example, the controller 11 of the embodiment of FIG. 3 is a SATA-compliant controller.

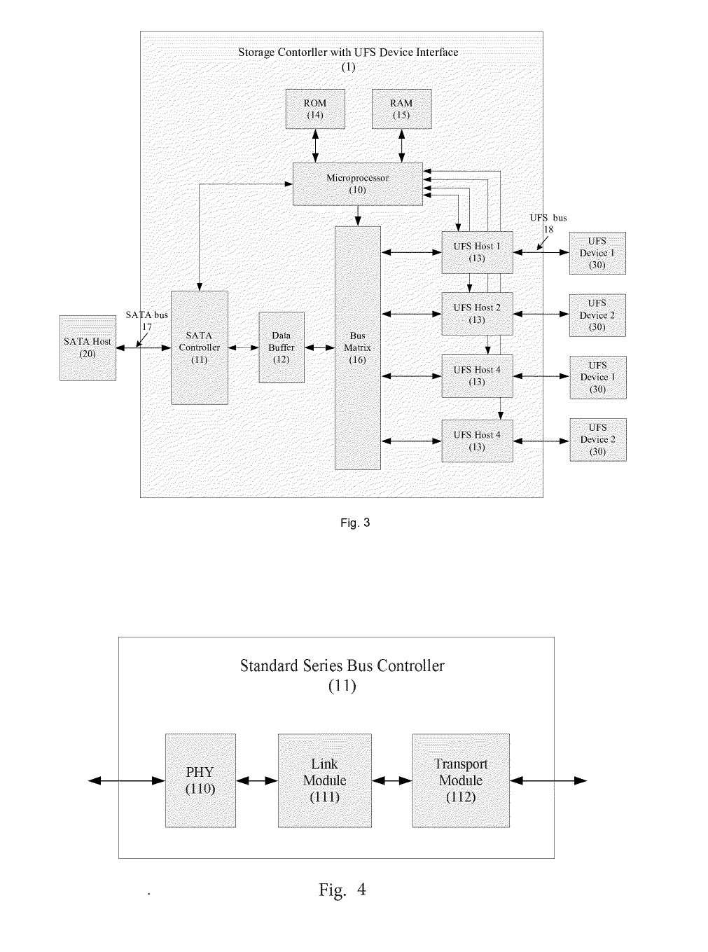

FIG. 4 shows further details of the controller 11 of the interface 1, in accordance with an embodiment of the invention. The controller 11 is shown to include a physical module 110, a link module 111 and a transport module 112. The link module 111 is shown coupled to the transport module 11 and the physical module 110. The module 110 typically communicates with an external host. For example, in the embodiments of FIGS. 3 and 4, the module 110 communicates with the host 20. The transport module 112 typically communicates with the data buffer 12 of the various embodiments of the interface 1. The physical module 110 operates at the physical layer of a network system, whereas, the transport module 112 operates in the transport layer and the link module 111 operates at the link layer of a network system. A host can access the interface 1 by the controller 11 and its accessible physical space is the sum of all of the physical space accessed by all of the USF host interfaces 13.

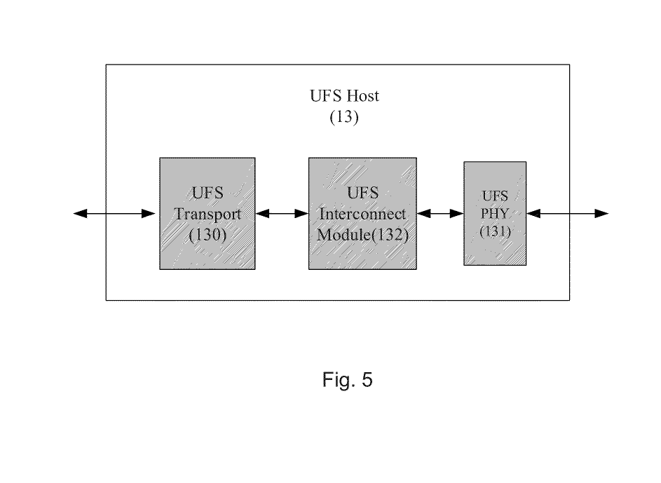

FIG. 5 shows further details of the UFS host 13, in accordance with various embodiments of the invention. The UFS host interface 13 is shown to include a UFS transport module 130, a UFS interconnect module 132 and a UFS physical module 131. The UFS interconnect module 132 is shown coupled to the UFS physical module 131 and the UFS transport module 130. The UFS physical module 131 typically communicates with an external host. For example, in the embodiments of FIGS. 2 and 3, UFS transport module 130 communicates with the host 20. The UFS physical module 131 typically communicates with the data buffer 12 of the various embodiments of the interface 1. The UFS interconnect module 132 serves to couple the transport and the physical layers together. The UFS physical module 131 operates at the physical layer and can interact with a storage device or system, as an example.

Although the description has been described with respect to particular embodiments thereof, these particular embodiments are merely illustrative, and not restrictive.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

What we claim is:

1. A storage controller with Universal Flash Storage (UFS) interface comprising:
a series bus controller responsive to information from a first externally-located host;
a microprocessor coupled to the series bus controller and responsive to the information and operable to generate an output;
one or more UFS host interfaces responsive to the output of the microprocessor and operable to generate information to one or more externally-located UFS devices, the number of externally-located UFS devices being equal to the number of UFS host interfaces, wherein the UFS host devices cause simultaneous communication of at least some of the information to the externally-located UFS devices.

2. The storage controller with UFS interface of claim 1, wherein the host is compliant with one of USB, SATA or PCIe.

3. The storage controller with UFS interface of claim 1, wherein the series bus controller is operable to communicate with a PCIe host.
